(19) United States
(12) Patent Application Publication
(10) Pub. No.: US 2011/0131068 A1
(43) Pub. Date: Jun. 2, 2011

(54) IN KIND PARTICIPATING PREFERRED SECURITY

(76) Inventors: William A Lupien, Coeur d'Alene, ID (US); John T. Rickard, Larkspur, CO (US); Farhad Abasov, Toronto (CA)

(21) Appl. No.: 12/989,541

(22) PCT Filed: Apr. 24, 2009
(86) PCT No.: PCT/US09/41616

§ 371 Date: Jan. 7, 2011

Related U.S. Application Data
(60) Provisional application No. 61/047,554, filed on Apr. 24, 2008.

(51) Int. Cl. G06Q 40/00

(52) U.S. Cl. 705/4; 705/35

(57) ABSTRACT

The present invention is generally directed to systems and methods for creating a new hybrid financial instrument, which addresses key concerns of investors and meets the financing requirements of investee companies. An embodiment of the present invention describes a new type of security called an “in-kind participating preferred security” (IPPS). The IPPS contract entitles the holder to a contingent in-kind dividend, payable periodically in the commodity produced by the issuer or in cash, which ever is of greater value. At expiration, the IPPS is redeemed by the company at its in-kind par value upon origination or in cash, which ever is greater.

### BACKGROUND OF THE INVENTION

1. Technical Field

The present invention relates to a financial instrument of an entity and a related business method.

2. Related Art

Companies that grow crops (such as wheat, corn, soybeans and lumber), extract minerals (such as gold, platinum, silver and other precious metals as well as non-precious metals or fertilizers such as potash or phosphate), mine stones (such as diamonds, sapphires, rubies and other precious and semi-precious stones) or otherwise produce a commodity frequently are unable to raise financing on appropriate terms. For instance, a moderately sized mining company is often unable to obtain a share valuation commensurate with its profit potential. Similarly, a farming business frequently is forced to forward sell its crop before planting, at a time when the value of the crop may be reduced.

Historically traditional equity and debt instruments have been utilized by producers of commodities, such as for example, mining companies, to raise funds for their operations. Recently, however, miners and investors alike have encountered serious constraints in using traditional financing methods.

Equity—periodic stock issuance to raise capital has been a favorite financing tool for commodity producers, such as junior and mid-tier miners, for years. In recent months, with the global credit crisis and its negative impact on the world stock markets, investors in commodity production companies have become extremely cautious. The ensuing slump in the stock prices of junior miners, for instance, has significantly impeded equity financing at this point. Any attempt to raise cash through stock issuance at depressed or low prices will dramatically dilute companies' existing shareholders even if new investors are found to raise such equity.

Debt—bank financing is another avenue that commodity production companies can pursue. However, there are a couple of major issues with such financing that make it unattractive to companies and their shareholders. First, some of these companies cannot collateralize their existing assets. Second, banks almost always require hedging of production in order to ensure their payback, thus, limiting companies' and their shareholders' exposure to potential upside in commodity price increase. Obviously, the foremost reason for investors to become shareholders in a commodity production company is their belief in the upside of a particular resource or commodity. Investors prefer to invest in companies with no hedged production. For example, the hedging of the books has kept some mining company stocks at relatively low levels despite the dramatic increase in gold price.

Therefore, it is becoming evident that traditional financing mechanisms do not meet either investors' or companies' fundamental interests and in fact, limit their rapid growth. The most obvious proof is the dichotomy between current depressed stocks of junior gold companies and the rising gold price. The “normal” expectation is that juniors' stocks should rise faster than physical gold price due to the leverage that mining companies offer.

Thus, there is a need for a mechanism to finance the production of a commodity that is more closely aligned to the expected returns from the venture (in a probabilistic sense).

### SUMMARY OF THE INVENTION

In the past several years there has been feverish activity in the commodities sector, which has been experiencing its latest upward cycle. The exploration and development companies involved in the sector have mainly resorted to traditional equity and debt financing to raise the funds required to acquire, explore, develop, and bring to production prospective resources. However, the last few months have also demonstrated the limitations of traditional financing methods, especially as applied to junior or mid-tier mining companies.

One aspect of the present invention provides a new hybrid financial instrument. A first embodiment of the present invention provides a financial instrument called an In-Kind Participating Preferred Security (IPPS). This instrument can be used to finance the production of commodities and addresses key concerns of investors and meets the financing requirements of investee companies. In this first embodiment, the IPPS combines the conventional rights of a preferred stock with the companies' ability to pay dividends in kind. It will be apparent to one of ordinary skill in the art that the new hybrid financial instrument can be represented by one financial instrument or by a set of financial instruments where one instrument, such as a bond or warrant, pays an in-kind dividend, and another instrument, such as a credit default swap, pays an additional in-kind dividend that covers the risk of the investment.

In this first embodiment, the IPPS allows a company to raise much needed capital for commodities' development and production without hedging its books and diluting its shareholders. This embodiment also provides investors with a way of participating in the strength of commodities and upside potential of junior companies with healthy dividend and return of principle once production is underway.

A second embodiment of the present invention creates a new type of contingent, in kind dividend payment. Desirably, the IPPS contract entitles the holder to a contingent in-kind dividend, payable periodically in a specified amount of the commodity produced by the issuer. In an alternative embodiment, the IPPS dividend is paid to the holder of the IPPS in kind or in cash. In some further embodiments the holder receives whichever type of dividend is of the greater value on some specified date, such as a record date. In other embodiments, the holder is able to choose the form of the dividend.

In a still further alternative embodiment, at expiration (or redemption), the IPPS is redeemed by the company at its in-kind par value upon origination. In a yet still further alternative embodiment, the IPPS is redeemed by the company at its par value upon origination in cash. In a yet still further alternative embodiment, the IPPS is redeemed by the company at its par value upon origination, in kind or on cash, which ever is greater on some specified date, such as a record date. In other embodiments, the holder is able to choose the form of the dividend.

Desirably, if the IPPS cannot be redeemed due to defaulting on production or to enterprise failure, the IPPS converts to common stock in some specified ratio, for instance five (5) shares of common stock for each IPPS contract. In another embodiment, the IPPS would convert to common stock in some potentially different ratio even in the absence of default.

In some embodiments of the present invention the dividend payments are not uniform. In some other embodiments the dividend payments are not periodic in time. In still other embodiments, the dividend payments are neither uniform nor periodic in time.

Desirably, the dividend payments accrue if unpaid from period to period. It is further desirable that any dividend obligations accrue with an interest penalty on either an in kind or cash basis if unpaid.

Desirably, the IPPS dividend payment is contingent upon the issuer not defaulting on production throughout the lifetime of the dividend obligation.

In a first example, if the issuer is a gold mining company, then the contingent in-kind dividend payments would be specified in ounces of gold each period over the course of the dividend obligation. However, in this preferred embodiment, if the gold price is less than its price at origination of the IPPS contract, the holder is entitled to receive a higher in-kind dividend equal to the cash equivalent of the dividend obligation (or actual cash).

There is a plurality of conventional mechanisms by which the dividend obligation may be attached to the IPPS. In one embodiment, the dividend obligation is attached directly in the terms of the security. In another embodiment, the dividend obligation is attached as a set of contingent (non-recourse) futures contracts for physical delivery issued concomitant with the security. The latter form might be more desirable for bulk commodities where the holder of the security has no interest in retaining the in-kind dividend.

In a still further embodiment of the present invention, the in kind dividend is deposited with an institution that accepts deposits of the commodity in issue such as the e-goldbank. (http://wvvw.freewebs.com/goldsure/index.htm)

Desirably, an IPPS can be successfully used to raise capital for precious metals miners such as gold and silver for their inflation-protection and value-preservation qualities. These are obvious situations where investors may want to choose between in-kind and cash payments.

It may also be used to fund operations in other mining sectors, sometimes, linking users and producers directly through the IPPS concept. For example, in the uranium sector, utilities may become direct investors in uranium miners as they will most likely want to get uranium as an in-kind payment when IPPS dividends begin flowing as they (utilities) will help finance a mining operation that will provide fuel for their reactors.

Desirably, an IPPS can be employed to raise capital for any company who seeks to develop and/or produce a commodity. Indeed, the IPPS is not limited to metal commodities such as gold, silver, or uranium, but can be used to finance any exploration, mining or production company for any commodity. Some additional examples of such commodities are crops such as, for example, wheat, corn, soybeans, rice and lumber; fertilizers such as, for example potash or phosphates; other metals such as, for example barium; precious stones such as, for example, diamonds, emeralds, sapphires and rubies and semi-precious stones such as, for example amethyst, lapis-lazuli, turquoise, aquamarine, topaz, moonstone, peridot, opal, tourmaline, zircon, chrysoberyl, alexandrite and many others.

### DESCRIPTION OF THE FIGURES

FIGS. 1-5 show interval Type 2 fuzzy membership function footprints of uncertainty (FOU) for variables involved in the IPPS dividend valuation.

### DETAILED DESCRIPTION

### Establishing Fair Market Value of the IPPS Dividend

As with all contingent securities, it is desirable to provide investors a guideline for determining the rational fair market value (FMV) of their investment because it promotes the liquidity of the investment in the market. A notable illustration of this phenomenon is the celebrated Black-Scholes option pricing formula which, shortly after its publication in the early 1970′s, fostered the founding of the Chicago Board Options Exchange and other options exchanges around the world and greatly increased the market liquidity for options trading.

The IPPS security has some features similar to a bond. Thus, the FMV of a bond is used as the starting point for determining the FMV of the IPPS dividend, and we consider the risk-free portion of the dividend that would be expected by investors. From there, the additional dividend required to account for the inherent risk of production default is derived. As noted previously, the IPPS can be represented by a single, hybrid instrument, or by a set of instruments that deliver the equivalent financial benefits and risks.

### Risk-Free Dividend

The FMV V_{T} of a default-risk-free bond (e.g., a Treasury bond) paying a dividend D_{T} is directly observable in the market for such securities, but also can be expressed formally as a net present value (NPV) computation on the returns to the purchaser:

$${V}_{T} = {D}_{T} {\sum }_{i = 1}^{n} {d}_{i} + {d}_{n} {V}_{par} \qquad ( 1 )$$

where dᵢ is the discount factor applied to the i^{th} dividend payment, and Vₚₐᵣ is the par value of the bond (i.e., $100 in the case of Treasury bonds). This equation relates the current market risk-free interest rate for the term of the bond (as reflected in the discount factors dᵢ) to the market price of the bond, given its dividend and redemption value.

Assuming that the dividends and redemption value of such a bond are to be paid in-kind and the commodity appreciation/discount factor for the i^{th} dividend payment is aᵢ, equation (1) can be generalized to represent the FMV V_{RF} of a hypothetical risk-free bond paying an in-kind dividend D_{RF} as

$${V}_{RF} = {D}_{RF} {\sum }_{i = 1}^{n} {d}_{i} {a}_{i} + {d}_{n} {a}_{n} {V}_{par} , \qquad ( 2 )$$

This equation is the NPV of the bond taking into account the changes in value of the in-kind returns (the aᵢ will be greater than unity for an appreciating commodity, and less than unity for a depreciating commodity). The commodity appreciation factors are nominally observable in the market via the price of futures contracts for the commodity, but as described below, the present invention permits a range of values to be used in this analysis, as opposed to only point values. A no-arbitrage argument requires that the above two instruments have identical value, thus V_{T} in (1) can be equated to the right-hand side of (2), and the resulting equation can be solved for the in-kind dividend D_{RF} to yield

$${D}_{RF} = \frac{{V}_{T} - {d}_{n} {a}_{n} {V}_{par}}{{\sum }_{i = 1}^{n} {d}_{i} {a}_{i}} \qquad ( 3 )$$

The value V_{T} can be expressed in basis points (bp) relative to its par value, which is denoted by V_{T(bp)}, as

$${V}_{T} = \frac{{V}_{T ( bp )}}{{10}^{4}} {V}_{par} \qquad ( 4 )$$

Substituting this into (3) obtains the following:

$$\begin{matrix}{D}_{RF} = \frac{\frac{{V}_{T ( bp )}}{{10}^{4}} {V}_{par} - {d}_{n} {a}_{n} {V}_{par}}{{\sum }_{i = 1}^{n} {d}_{i} {a}_{i}} \\ = [ \frac{\frac{{V}_{T ( bp )}}{{10}^{4}} - {d}_{n} {a}_{n}}{{\sum }_{i = 1}^{n} {d}_{i} {a}_{i}} ] {V}_{par}\end{matrix} \qquad ( 5 )$$

Thus the risk-free component of the in-kind dividend can be expressed in basis points as D_{RF(bp)}, by dividing (5) by Vₚₐᵣ and multiplying the result by 10⁴:

$${D}_{RF ( bp )} = \frac{{V}_{T ( bp )} - {10}^{4} {d}_{n} {a}_{n}}{{\sum }_{i = 1}^{n} {d}_{i} {a}_{i}} \qquad ( 6 )$$

### Production Default Risk Dividend Component

The IPPS is not a risk-free security, since there is a possibility of default on production. Thus, the purchaser of this security will desire an incremental addition to the risk-free in-kind dividend to compensate him for this default risk. In effect, the purchaser is demanding the issuer additionally to pay the premiums (in-kind) on a credit default swap (CDS) insurance contract where the IPPS is the underlying credit instrument. These premium payments (in bp) are added to the risk-free dividend computed via (6). Thus the total FMV dividend will be the sum of (6) plus the premium on this insurance contract, which is now addressed.

From the issuer's perspective, the value of this incremental addition to the IPPS dividend is equal to the expected present value (EPV) of the corresponding in-kind insurance premium payment stream. These payments are discounted both by the assumed risk-free interest rate and the assumed probability that the enterprise is successful in reaching production. However, they may be appreciated by assumed gain in the value of the in-kind commodity in which the dividends are paid. From the IPPS purchaser's perspective, the EPV of the default insurance payment stream must compensate for the expected loss he would suffer upon the default of the dividend payments.

Thus, this additional IPPS dividend component effectively provides a risky insurance policy against default on production, where the insurance premiums (i.e., the dividends) are paid by the issuer in the form of additional in-kind payments. It is risky insurance because in the event of default on production, the dividend payments cease, and the IPPS holder is left with a recovery rate equivalent to the fractional value of the IPPS after default relative to its value at origination.

With these preliminaries, suppose the IPPS risk dividend is calculated in terms of basis points on its origination value, for n time periods. Also assume that the dividends are to be paid uniformly over consecutive time periods, although the pricing model can be easily adapted to accommodate a variable payment stream and/or accrued payments. The following terms are defined:

Sₙ=risk dividend payments (per dollar of IPPS value) to time period n (7)

Δᵢ=length of time period i in years (8)

Pᵢ=probability of survival of production to time period i (9)

dᵢ=risk-free discount factor to time period i (10)

aᵢ=appreciation factor of in-kind payment to time period i (11)

R=recovery rate of IPPS security upon default of production (12)

A rational pricing of this component of the dividend on the IPPS will equate the EPV of the in-kind payment stream plus the expected accrual value of halted payments upon default of production to the EPV of the loss suffered upon default of production, since the latter is the event that is being insured against by these payments. Assuming that production is sustained over the prescribed dividend interval, the IPPS purchaser receives the in-kind payments each period. However, upon default of production, they would suffer an expected loss corresponding to a factor (1−R) times the probability- and time-discounted value of the IPPS at origination. This relationship can be expressed in the following equation:

$${S}_{n} {\sum }_{i = 1}^{n} {Δ}_{i} {P}_{i} {d}_{i} {a}_{i} + {S}_{n} {\sum }_{i = 1}^{n} \frac{{Δ}_{i}}{2} {( {P}_{i - 1} - {P}_{i} )}_{i} {d}_{i} {a}_{i} = ( 1 - R ) {\sum }_{i = 1}^{n} ( {P}_{i - 1} - {P}_{i} ) {d}_{i} \qquad ( 13 )$$

The left hand side is the expected value of the in-kind payment stream (per dollar of IPPS value), discounted by the risk-free interest rate and appreciated by the increase in value of the in-kind commodity with time (typically with a floor of no appreciation), plus the expected value of the halted (discounted and/or appreciated) payment stream upon default. The ½ in the summand of the second term is due to the averaging over Δᵢ of when the payments halt during that time period, given that they do halt during that period. Taken together, these two terms represent the EPV of the IPPS issuer's contingent payment stream. The term on the right represents the EPV of the loss per dollar of IPPS investment upon default of production, discounted only by the risk-free interest rate (since any recovery will be in dollars, not in-kind). The term (Pᵢ₋₁−Pᵢ)≧0 equals the probability of default of production in period i (i.e., survival of production to period i−1 followed by default in period i).

Rearranging to solve for Sₙ, we obtain

$$\frac{{S}_{n}}{2} {\sum }_{i = 1}^{n} {Δ}_{i} ( {P}_{i - 1} + {P}_{i} ) {d}_{i} {a}_{i} = ( 1 - R ) {\sum }_{i = 1}^{n} ( {P}_{i - 1} - {P}_{i} ) {d}_{i} \\ {S}_{n} = \frac{2 ( 1 - R ) {\sum }_{i = 1}^{n} ( {P}_{i - 1} - {P}_{i} ) {d}_{i}}{{\sum }_{i = 1}^{n} {Δ}_{i} ( {P}_{i - 1} + {P}_{i} ) {d}_{i} {a}_{i}} \qquad ( 14 )$$

The survival probabilities Pᵢ are typically modeled as a function of hazard rates λᵢ, i.e., the conditional probability of a default in period i, given that no default has occurred prior to period i. Thus:

$${P}_{1} = 1 - {λ}_{1} \\ {P}_{2} = {P}_{1} ( 1 - {λ}_{2} ) = ( 1 - {λ}_{1} ) ( 1 - {λ}_{2} ) \\ ⋮ \\ {P}_{i} = ( 1 - {λ}_{1} ) … ( 1 - {λ}_{i} ) \qquad ( 15 )$$

and the a priori probability of default in period i is given by

Pᵢ₋₁−Pᵢ=(1−λ₁) . . . (1−λᵢ₋₁)λᵢ (16)

Thus, given a set of survival probabilities Pᵢ (or equivalently, hazard rates λᵢ), the time period durations Δᵢ, the discount and appreciation factors dᵢ and aᵢ, and the recovery rate R, we can compute the appropriate risk dividend per dollar of common value at origination using (14). The total IPPS dividend D_{T(bp)} (in basis points) is the sum of D_{RF(bp)} in (6) and 10⁴Sₙ in (14) (the factor 10⁴ converts the value of Sₙ to basis points):

$$\begin{matrix}{D}_{T ( bp )} = {D}_{RF ( bp )} + {10}^{4} {S}_{n} \\ = \frac{{V}_{T ( bp )} - {10}^{4} {d}_{n} {a}_{n}}{{\sum }_{i = 1}^{n} {d}_{i} {a}_{i}} + \frac{2 \times {10}^{4} ( 1 - R ) {\sum }_{i = 1}^{n} ( {P}_{i - 1} - {P}_{i} ) {d}_{i}}{{\sum }_{i = 1}^{n} {Δ}_{i} ( {P}_{i - 1} + {P}_{i} ) {d}_{i} {a}_{i}} .\end{matrix} \qquad ( 17 )$$

### Fuzzy Representations of Parameter Values

Traditional financial analysis such as the above assumes precise knowledge of the parameter values involved in the various formulas. However, this is often an overly restrictive assumption, as these values may not be known precisely. One approach to generalizing these formulas is to assume these parameters are random variables, assign each of them an appropriate probability density function to represent the uncertainty in their values, and then attempt, where feasible, to compute the corresponding probability density function of the variable defined by the formula. Often this computation is analytically intractable, in which case one resorts to Monte Carlo simulations to estimate the probability density of the variable defined by the formula. From this density, parameters such as the mean and standard deviation can then be calculated or estimated to provide a statistical characterization of the variable of interest.

An alternative method for incorporating imprecision in one's knowledge of the parameters in a formula is to treat them as fuzzy variables. Compared to probability theory, fuzzy theory has a relatively brief history, having been pioneered in 1965 in a seminal paper by Professor Lotfi Zadeh of the University of California, Berkeley (“Fuzzy Sets”, Information and Control, vol. 8, no. 3, pp. 338-353, 1965, which is hereby incorporated by reference). Since then, the mathematics and science of this discipline has grown and matured very rapidly, primarily due to its ready connection with the representations and processes of human language and inference. In particular, fuzzy theory is uniquely adept at translating linguistic descriptions of variables and logical rules obtained from human expert judgments into corresponding mathematical representations and inferencing algorithms than are amenable to implementation on a digital computer. Fuzzy logic is currently used successfully in numerous practical applications (e.g., stabilizing digital cameras against jitter, regulating the dispensing of soap in washing machines, controlling the actions of robotic mechanisms) where analytical models have proven intractable.

A fuzzy variable is characterized by a fuzzy membership function, which can be thought of somewhat analogous to a probability density function, but instead of describing the likelihood of a particular, but unknown, value of the parameter, it describes the degree of membership (between zero and one) of a set of values in an underlying domain, the latter set typically being a continuous range of real number values over some interval. The simplest type of fuzzy membership function has only two degrees of membership: unity (viz., equal to 1) over some interval [a, b], and zero elsewhere, and is therefore described as an interval-membership function. This is equivalent to characterizing our knowledge of a fuzzy variable as uniformly imprecise over this interval. Thus, rather than assuming a single (possibly unknown) value of the parameter within this interval, as in probability theory, we treat it as having uniform membership in all values within this interval, i.e., every value within this interval is equally valid to describe the variable.

The next more general fuzzy membership functions map values in the underlying fuzzy set to precise membership values lying continuously between zero and unity, which allows variable degrees of membership to be described. These are denoted Type-1 fuzzy membership functions, and they are by far the most commonly used in applications to date. For example, consider the fuzzy set “tall” (with reference to the height of adult humans). This is a typically imprecise notion of the sort that humans deal with routinely. A Type-1 fuzzy membership function for this set might have zero value for heights less than 5′ 6″, with the degree of membership ramping up to unity for heights of 6′ 3″ and above. A particular individual's height, if known precisely, would then correspond to a particular membership value in the set “tall”, e.g., a person of height 5′ 9″ might have a 0.33 membership in this set.

The most general type of fuzzy membership functions currently in use admit additional imprecision, in the fuzzy membership values themselves, and are known as Type-2 fuzzy membership functions. In the above example of the fuzzy set “tall”, additional imprecision can arise from differing perspectives on the appropriate Type-1 membership function to describe degrees of “tall”, or from imprecision in the height measurement of an individual (due to height variations over the day or to measurement error).

Thus, rather than a single curve describing a Type-1 membership function, a Type-2 membership function is characterized by a “footprint of uncertainty” (FOU) where, for each value of the underlying fuzzy set (e.g., a height of 5′ 9″), the membership in the fuzzy set “tall” is itself a fuzzy variable with an interval membership function defined over some sub-interval of [0,1], the latter being the domain of allowable values for degrees of fuzzy membership. Thus a height of 5′ 9″ might have unity membership over the interval [0.3, 0.4] in the fuzzy set “tall”, and zero membership elsewhere. This case is known as an “interval Type-2” membership function.

A key feature of interval Type-2 membership functions is that they are completely specified by their (Type-1) upper and lower membership functions, which are the respective upper and lower bounding functions of their footprint of uncertainty. Thus all manipulations of these functions can be accomplished via computations on these two Type-1 membership functions.

An even further generalization will admit Type-1 membership functions to describe the membership degrees of a particular underlying value of height in the fuzzy set “tall”. For example, rather than the unity membership value over the interval [0.3, 0.4] in the above example, we might have a triangular shaped membership function that peaks at the point 0.35, and tapers to zero on either side at the points 0.3 and 0.4, respectively. This case is known as a “general Type-2” membership function. The manipulation of these membership functions is computationally more difficult than interval Type-2 membership functions, and obtaining the additional detail required to specify them is often problematic. For these reasons, interval Type-2 membership functions are most commonly used in applications.

A discussion of Type-1 and Type-2 fuzzy sets can be found in Mendel, J. M., Uncertain Rule-Based Fuzzy Logic Systems. Upper Saddle River, N.J.: Prentice-Hall, 2001, which is hereby incorporated by reference.

### Interval Values for IPPS Input Parameters

The initial analysis of the FMV of the IPPS dividend assumed point values of all input parameters in the formula of equation (17). In a further embodiment of the present invention, interval fuzzy membership functions μ_{P}_{ᵢ}(y), μ_{d}(y), μₐ_{ᵢ}(y) and/or μ_{R}(y) are used instead of point values of Pᵢ, aᵢ, dᵢ and/or R to compute a corresponding interval membership for the IPPS dividend D_{T(bp)}. In this further embodiment, any of these membership functions is thus represented in the form

$$μ ( y ) = \{ \begin{matrix}1 & y ∈ [ a , b ] \\ 0 & elsewhere ,\end{matrix} \qquad ( 18 )$$

i.e., the relevant quantity has unity membership over the interval [a, b] denoting an appropriate range of values characterizing the imprecision in the knowledge of the corresponding variable, and zero membership elsewhere. In this further embodiment, these interval values might result from polling a single expert to provide his assessment of these quantities, a task to which human experts are particularly well suited.

In a further embodiment, the interval membership function results can be generalized to allow for Type-1 fuzzy membership functions to describe these values. This enables the computation of a corresponding Type-1 fuzzy membership function for the IPPS dividend.

In yet a further embodiment, multiple interval values may result from polling a plurality of expert panels, each panel comprised of a plurality of experts in the same or related fields, to obtain their collective assessment of interval estimates of the input variables. The compelling advantage of this further generalization is that the multiple intervals so obtained can then be aggregated into a much richer description of imprecision in the input variables provided by interval Type-2 fuzzy membership functions. One can then compute a corresponding interval Type-2 fuzzy membership function for the IPPS dividend.

There is no record in the literature of the use of Type-2 fuzzy membership representations for the input variables for pricing the payment streams of securities. Appadoo, Bhatt and Bector disclose the use of Type-1 fuzzy numbers (which have convex Type-1 membership functions) in possibilistic mean and covariance calculations in financial applications, including present value payments in Appadoo, S. S., Pricing financial derivatives with fuzzy algebraic models: A theoretical and computational approach, Ph.D. Thesis, Dept. Business Administration, Univ. Manitoba, Winnipeg, Manitoba, Canada, 2006, and Appadoo, S. S., S. K. Bhatt and C. R. Bector, “Application of possibility theory to investment decisions,” Journal of Fuzzy Optimization and Decision Making, vol. 7, pp. 35-57, 2008, which are hereby incorporated by reference. However, the use of Type-1 fuzzy membership functions is problematic in that it implicitly assumes precise knowledge of the membership function, which is unrealistic in real-world applications.

### Interval Values of the Risk-Free Dividend Component

The interval value of the risk-free dividend component D_{RF(bp)} in equation (6) is now computed when the input variables dᵢ and/or aᵢ are allowed to take on interval values. Note that the numerator of (6) will always be positive (i.e., there would never be a negative dividend). If the dᵢ and/or aᵢ are allowed to take on interval values, then the minimum value of D_{RF(bp)} will correspond to the maximum values of dᵢ and aᵢ (which maximize the denominator and minimize the numerator), whereas the maximum value of D_{RF(bp)} will correspond to the minimum values of dᵢ and aᵢ. Let these values be denoted by dᵢ^{min},dᵢ^{max}, aᵢ^{min} and aᵢ^{max}, respectively. Then D_{RF(bp)} takes on corresponding values in the interval [D_{RF(bp)}^{min},D_{RF(bp)}^{max}], where

$$\begin{matrix}{D}_{RF ( bp )}^{min} = \frac{{V}_{T ( bp )} - {10}^{4} {d}_{n}^{max} {a}_{n}^{max}}{{\sum }_{i = 1}^{n} {d}_{i}^{max} {a}_{i}^{max}} \\ and & ( 19 ) \\ {D}_{RF ( bp )}^{max} = \frac{{V}_{T ( bp )} - {10}^{4} {d}_{n}^{min} {a}_{n}^{min}}{{\sum }_{i = 1}^{n} {d}_{i}^{min} {a}_{i}^{min}} & ( 20 )\end{matrix}$$

### Interval Values of the Production Default Risk Dividend Component

Desirably, the equation for Sₙ in (14) also has interval values when one or more of its input variables have interval values. The left- and right-hand endpoints of the Sₙ interval cannot be calculated analytically, so it is preferred that a nonlinear constrained optimization algorithm is used to find the minimum and maximum values of Sₙ subject to the interval constraints on the input parameters. It will be obvious to one skilled in the art that these are complex computations typically requiring hundreds of thousands or more of individual calculations of a detailed nature, and thus it will be impractical to perform them other than by machine-implemented algorithms.

An example of this embodiment of the present invention provides an IPPS with a 5-year annual in-kind dividend for a gold mining company. Desirably the interval values of the hazard rates, risk-free interest rate, appreciation rate and recovery rate in this example are assessed to be:

$$λ = [ \begin{matrix}0.03 & 0.05 \\ 0.025 & 0.045 \\ 0.02 & 0.04 \\ 0.015 & 0.035 \\ 0.01 & 0.03\end{matrix} ]$$

$$r = [ \begin{matrix}0.04 & 0.06\end{matrix} ]$$

$$a = [ \begin{matrix}- 0.05 & 0.0\end{matrix} ]$$

$$R = [ \begin{matrix}0.1 & 0.2\end{matrix} ]$$

In other words, in this example, the hazard rates for the 5-year period are 3-4% for year 1, 2.5-3.5% for year two, 2-3% for year 3, 1.5-2.5% for year 4, and 1-2% for year 5; the risk-free interest rates are 4-6% and the appreciation rates are −5-0% for all years (these can be year-specific if desired); and the recovery rate is 10-20%. For this case, the risk dividend interval is calculated as [574.2 1488] basis points, i.e., a rational fair market value for the risk dividend ranges over this interval, reflecting the uncertainty in the risk dividend arising from the uncertainties in the input variables. To translate the interval values of hazard rates, interest rates and appreciation factors into the corresponding interval values of survival probabilities, discount rates and appreciation rates, desirably repeated use is made of the interval multiplication identity

[a,b]×[c,d]=[min(ac,ad,bc,bd), max (ac,ad,bc,bd)] (21)

Preferably, for the relatively modest spans of the input variable intervals in this example, the dividend interval length spans greater than a factor of two in basis point values, which indicates the perhaps larger than expected sensitivity of the dividend to variations in the input variables.

The total dividend is the sum of the risk-free dividend and the risk dividend. For point inputs, this is given by equation (17). For interval inputs, the risk-free dividend interval [D_{RF(bp)}^{min},D_{RF(bp)}^{max}] is calculated from (19)-(20), and the risk dividend interval [Sₙ^{min},Sₙ^{max}] is calculated using the constrained nonlinear optimization procedure described above. These two intervals are summed using standard interval arithmetic to produce the total dividend interval (in bp):

[D^{min},D^{max}]=[D_{RF(bp)}^{min},D_{RF(bp)}^{max}]+10⁴[Sₙ^{min},Sₙ^{max}]=[D_{RF(bp)}^{min}+10⁴Sₙ^{min},D_{RF(bp)}^{max}10⁴Sₙ^{max].} (22)

### Type-1 and Interval Type-2 Fuzzy Input Variables

It is particularly preferred that the computations are extended to the case of Type-1 fuzzy membership functions for the input variables through the use of α-cuts of the fuzzy membership functions. α-cuts are described by Klir and Yuan in Fuzzy Sets and Fuzzy Logic: Theory and Applications, Upper Saddle River, N.J.: Prentice-Hall, 1995, which is hereby incorporated by reference. It is still further preferred that Zadeh's extension principle is also used in these computations. Zadeh's extension principle is described in Zadeh, L. A., “The concept of a linguistic variable and its application to approximate reasoning-1,” Information Sciences, vol. 8, pp. 199-249, 1975, which is hereby incorporated by reference. Zadeh's extension principle is also applicable to the approach described by Wu and Mendel in “Aggregation using the linguistic weighted average and interval Type-2 fuzzy sets,” IEEE Trans. Fuzzy Systems, vol. 15, no. 6, pp. 1145-1161, December 2007, which is hereby incorporated by reference. Desirably there are m (the number of α-cuts) pairs of intervals for each membership function, and the computation of each α-cut interval [D^{min}(αⱼ),D^{max}(αⱼ)], j=0, . . . m of the dividend membership function is preferably carried out using the corresponding set of α-cut intervals of the input variables, in the same fashion as described above for a single interval.

It is still further preferred that the computations are extended to the case of interval Type-2 fuzzy membership functions by applying the Type-1 results to the upper and lower membership functions of the footprints of uncertainty (FOU) of the input variables, which calculates the corresponding upper and lower membership functions of the FOU of the dividend. Desirably, this extension only amounts to a doubling of the computations involved in the Type-1 case.

A preferred Type-2 membership function of the dividend can be type-reduced to its corresponding Type-1 membership function (which is an interval) by calculating its centroid as described by Mendel in Uncertain Rule-Based Fuzzy Logic Systems. Preferably, the centroid interval can be defuzzified by calculating its midpoint, which results in a scalar value for the dividend. This scalar value could be interpreted as the most “appropriate” dividend value for the IPPS. Note, however, that both the type-reduction operation and the defuzzification operation are successively collapsing the much richer depiction available in the Type-2 dividend membership function. Thus, the ability to visualize the full Type-2 membership functions provides a great deal more insight into the dividend behavior as a function of the input variable membership functions. This greater insight provides a quantitative basis for negotiating an agreed IPPS dividend with the issuer, which value may not necessarily correspond exactly to the scalar value described above.

The preferred input variable Type-2 membership functions can be extracted by polling multiple experts for simple interval inputs, and then aggregating these intervals into Type-2 membership functions using a variety of techniques such as those described by Wu and Mendel in “Type-2 fuzzistics for symmetric interval type-2 fuzzy sets: Part 1: forward problem,” IEEE Trans. Fuzzy Systems, vol. 14, pp. 781-792, 2006, which is hereby incorporated by reference, and by Liu and Mendel in “An interval approach to fuzzistics for interval type-2 fuzzy sets,” Proc. IEEE International Conf. on Fuzzy Systems (FUZZ-IEEE 2007), pp. 1-6, July 2007, which is also hereby incorporated by reference. In a yet further preferred embodiment, both the issuer and the potential purchaser of the IPPS can employ their own panels of experts to arrive at their interval estimates of the fair market interval value of the dividend, which can then form the basis for the negotiations to determine the final value to be specified in the IPPS security contract. In a still further embodiment of the present invention the interval estimates for hazard rates, or their corresponding survival probabilities, are extracted for these quantities from the analysis of the historical experiences of an ensemble of similar companies.

Interval Type-2 Inputs Example

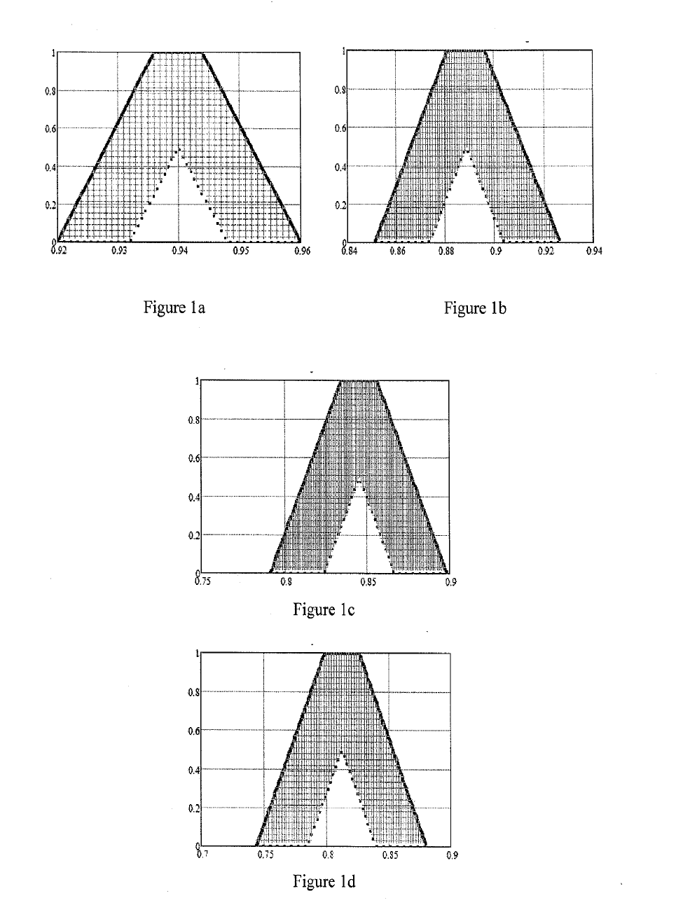

In an example of the interval Type-2 calculations for the total dividend, suppose that interval Type-2 membership functions (which are denoted by a “~” overbar) are given as \tilde{μ}_{P}(x), \tilde{μ}_{d}(x), \tilde{μ}ₐ(x), and \tilde{μ}_{R}(x) for the input variables shown in FIGS. 1-4, where in each case, the solid curve represents the upper membership function, the dotted curve represents the lower membership function, and the shaded region between these two curves is the FOU. As mentioned above, these functions can be derived directly from a set of interval data estimates provided by the members of an expert panel. All of the input interval Type-2 membership functions shown in this example have upper and lower bounding Type-1 membership functions that are simple trapezoids or triangles; however, arbitrary convex bounding functions may be employed.

Thus, for example, FIGS. 1a-1e graphically depict interval Type-2 membership functions of survival probability in years 1-5, respectively. The survival probability in year 1 is centered upon 0.94, but the membership function ranges over an interval from 0.92 to 0.96, with the highest membership values in the range from about 0.935 to 0.945. The survival probability membership functions for subsequent years shift downward, to one that is centered on 0.79 in year 5, with a somewhat broader range of values, as would be expected. It is important to note that all survival probabilities in these ranges (weighted by their corresponding membership interval) are simultaneously taken into account in the process of calculating the total dividend payment. Since the true survival probabilities cannot be known precisely a priori, the approach of the present invention allows the inherent imprecision regarding these probabilities to be factored into the dividend calculations. The same is true of the remaining input variables, whose values cannot be known precisely a priori.

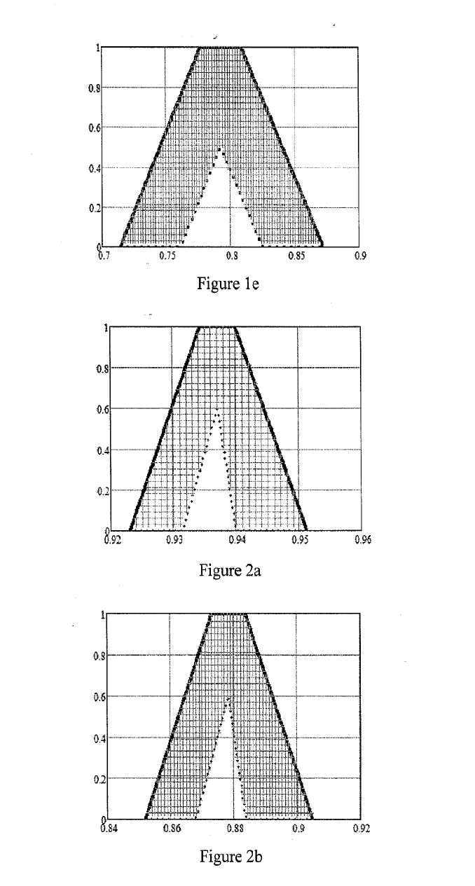

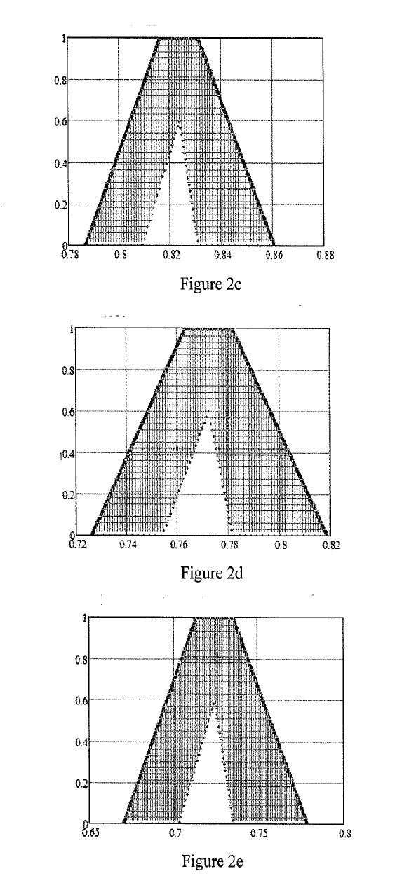

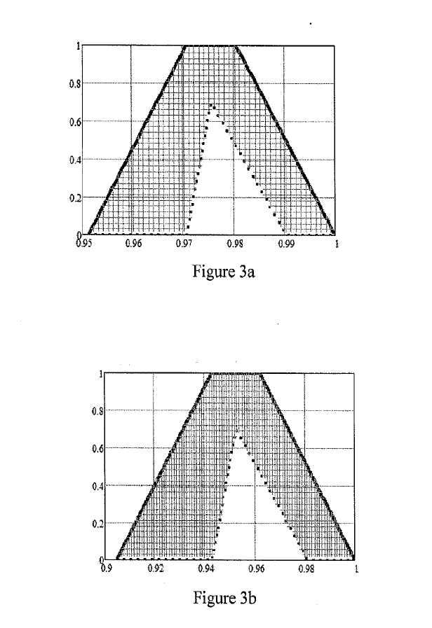

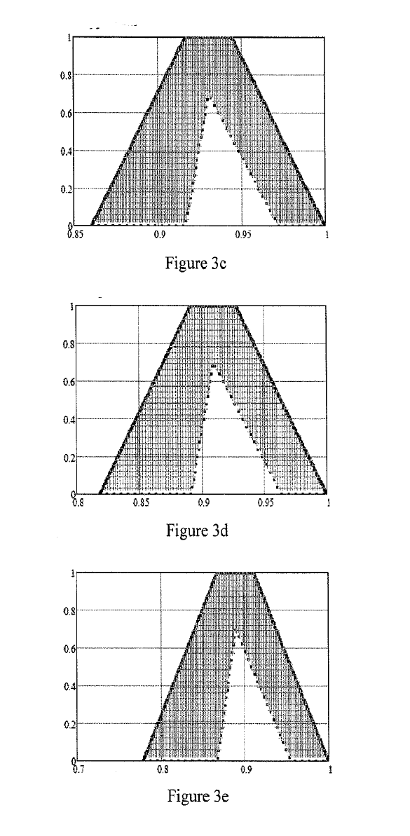

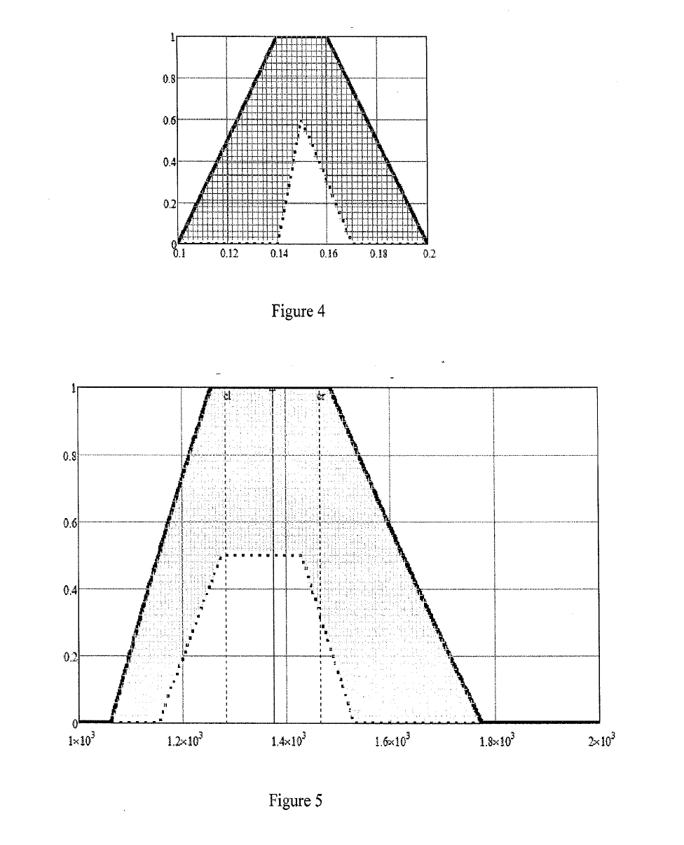

FIGS. 2a-2e, in a similar manner to FIGS. 1a-1 e graphically depict interval Type-2 membership functions for the discount factor in years 1-5, respectively. FIGS. 3a-3d graphically depict the interval Type-2 membership functions for appreciation factor in years 1-5, respectively and FIG. 4 graphically depicts the interval Type-2 membership function for recovery rate.

The corresponding interval Type-2 membership function for the total dividend \tilde{μ}_{S}(x) in basis points is shown in FIG. 5. Note that this function has its support over a rather large range from 1060 to 1075 basis points. However, calculating the centroid of this Type-2 membership function yields the narrower interval [1283 1465], whose midpoint is 1374 bp. The latter interval characterizes the essential “core” of the dividend Type-2 membership function, taking into account the complete distribution of fuzzy membership values. Note that \tilde{μ}_{S}(x) is not a symmetric function.

### Risk Dividend for Delayed Production

In some embodiments, a company may not be into production in the first year after issuance of the IPPS, but plans to be sometime in the future. In such cases, the company may want to issue an IPPS where the dividend payments start sometime in the future. In this case, the risk-free portion of the dividend accrues (with interest), but the risk dividend calculation must be modified. For example, the IPPS may pay out an in-kind dividend starting 3 years out, with payments made out to 10 years. In this case, the EPV of the risk dividend stream would be calculated with the summations on the left side of equation (14) starting with i=3 and going out to n=10. However, the EPV of the loss suffered upon default would include all time periods. Thus the same form of equation is used to compute the dividend, but the summations in the denominator are shifted appropriately.

In particular, let Sₙ_{₁}_{,n}_{₂} be the fair market value of the risk component of the dividend per dollar of IPPS purchase price for a preferred dividend paid over n₂−n₁ periods, starting at period n₁. Then analogous to (14),

$${S}_{{n}_{1} , {n}_{2}} = \frac{2 ( 1 - R ) {\sum }_{i = 1}^{{n}_{2}} ( {P}_{i - 1} - {P}_{i} ) {d}_{i}}{{\sum }_{i = {n}_{1}}^{{n}_{2}} {Δ}_{i} ( {P}_{i - 1} + {P}_{i} ) {d}_{i} {a}_{i}} \qquad ( 23 )$$

The denominator in (23) is smaller than the denominator in (14), while the numerators are identical, thus the risk component of the dividend payments for delayed production over the same number of periods will be higher. For example, with point values λ=0.03, interest rate r=4%, commodity annual appreciation rate of 10% and residual value R=10%, this component of the dividend payment would be 203.9 by for five years beginning immediately. However, if the dividend payments begin in year 5 and extend to year 10, this component of the dividend would be 253.3 bp.

Desirably, the previously described mathematics are applied to these delayed production dividends to calculate an interval Type-2 representation of fair market value, which may then be type-reduced and defuzzified to arrive at a scalar value of the dividend, or alternatively may be used as the basis for negotiating an agreed dividend with the issuer of the financial instrument.

1. A data processing system for pricing a financial instrument for the financing of the production of a commodity by a company, said data processing system comprising a computer configured to:
(a) a process and store data;
(b) calculate a fair market value of said financial product;
(c) wherein said computer is configured to calculate a fair market value of said financial product using at least one input data from the group consisting of: i) assumed survival probabilities as a function of time period; ii) assumed hazard rates as a function of time; iii) assumed risk-free interest rates and corresponding discount factors as a function of time; iv) assumed commodity appreciation or depreciation rates and corresponding appreciation or discount factors as a function of time; and v) assumed recovery rates, and combinations thereof; and
(d) transmit said fair market value of said financial product from the computer to an output device, the output device being configured to display a graphical representation of said present value of said financial product.

2. The data processing system of claim 1 further comprising a printer for printing the graphical representation of said fair market value of said financial product.

3. The data processing system of claim 1 wherein said input data comprises assumptions of interval data ranges from at least one expert.

4. The data processing system of claim 1 wherein said commodity is selected from the group consisting of gold, platinum, silver, or other precious metals.

5. The data processing system of claim 1 further comprising a printer configured to print a contract containing the terms of said financial product.

6. The data processing system of claim 1 wherein the production of said commodity comprises mining.

7. The data processing system of claim 1 wherein the production of said commodity comprises harvesting an agricultural crop.

8. The data processing system of claim 1 wherein said commodity is a non-precious metal.

9. The data processing system of claim 1 wherein said commodity is an agricultural fertilizer.

10. The data processing system of claim 1 wherein said commodity is a precious stone.

11. The data processing system of claim 1 wherein said commodity is a semi-precious stone.

12. A method for financing a commodity producing business comprising:
a. receiving, at a computer, input interval data concerning the assumed enterprise survival probabilities as a function of time;
b. receiving, at the computer, input interval data concerning the assumed enterprise hazard rates as a function of time;
c. receiving, at the computer, input interval data concerning the assumed risk-free interest rates and corresponding discount factors as a function of time;
d. receiving, at the computer, input interval data concerning the assumed commodity appreciation or depreciation rates and corresponding appreciation or discount factors as a function of time;
e. receiving, at the computer, input interval data concerning the assumed recovery rate;
aggregating said interval data into an interval Type-2 fuzzy membership function;
g. computing, by a processor embodied on the computer, based at least in part on the aggregated interval data, an interval Type-2 fuzzy membership function for the fair market value of a dividend paid by said commodity producing business;
g. computing, based at least in part on said interval Type-2 fuzzy membership function, a type-reduced interval fuzzy membership function for the fair market value of a dividend paid by said commodity producing business;
h. computing, based at least in part on said type-reduced interval fuzzy membership function for the fair market value of the dividend, the actual dividend of a financial instrument offered by said business;
i. generating a contract that pays said actual dividend of said financial instrument to an investor.

13. The method of claim 12 further comprising printing the contract.

14. The method of claim 12 further comprising electronically recording the contract.

15. The method of claim 12 further comprising paying said actual dividend in-kind.

16. The method of claim 12, wherein said contract includes a term for accruing interest for non-payment of said actual dividend.

17. The method of claim 12 wherein said financial instrument is comprised of a first financial instrument and a second financial instrument.

18. The method of claim 17 wherein said first financial instrument comprises a bond.

19. The method of claim 17 wherein said first financial instrument comprises a warrant.

20. The method of claim 17 wherein said first financial instrument comprises a financial instrument paying dividends in-kind.

21. The method of claim 17 wherein said first financial instrument comprises a financial instrument paying interest in-kind.

22. The method of claim 17 wherein said first financial instrument comprises a financial instrument paying interest and dividends in-kind.

23. The method of claim 17 wherein said second financial instrument comprises a credit default swap.

24. The method of claim 17 wherein said second financial instrument comprises an insurance contract against production default.

25. A method for financing a commodity producing business comprising:
a. receiving, at a computer, input interval data concerning the assumed enterprise survival probabilities to production as a function of time;
b. receiving, at the computer, input interval data concerning the assumed enterprise hazard rates for default of production as a function of time;
c. receiving, at the computer, input interval data concerning the assumed risk-free interest rates and corresponding discount factors as a function of time;
d. receiving, at the computer, input interval data concerning the assumed commodity appreciation/depreciation rates and corresponding appreciation/discount factors as a function of time;
e. receiving, at the computer, input interval data concerning the assumed recovery rates on the financial product investment in the event of default of production;
f. aggregating said interval data into an interval Type-2 fuzzy membership function;
g. computing, by a processor embodied on the computer, based at least in part on said aggregated interval data, an interval Type-2 fuzzy membership function for the fair market value of a dividend paid by said commodity producing business;
h. Using said interval Type-2 fuzzy membership function for the fair market value of the dividend to determine the actual dividend of a financial instrument offered by said business;
i. generating a contract for said financial instrument that pays said actual dividend to an investor.

26. The method of claim 25 further comprising printing the contract.

27. The method of claim 25 further comprising electronically recording the contract.

28. The method of claim 25 further comprising paying said actual dividend in-kind.

29. The method of claim 25, wherein said contract includes a term for accruing interest for non-payment of said actual dividend.

30. The method of claim 25 wherein said financial instrument comprises a first financial instrument and a second financial instrument.

31. The method of claim 30 wherein said first financial instrument comprises a bond.

32. The method of claim 30 wherein said first financial instrument comprises a warrant.

33. The method of claim 30 wherein said first financial comprises a financial instrument paying dividends in-kind.

34. The method of claim 30 wherein said first financial instrument comprises a financial instrument paying interest in-kind.

35. The method of claim 30 wherein said first financial instrument comprises a financial instrument paying interest and dividends in-kind.

36. The method of claim 30 wherein said second financial instrument comprises a credit default swap.

37. The method of claim 30 wherein said second financial instrument comprises an insurance contract against production default.

38. The method of claim 12, wherein said received interval data is determined by one or more experts.

39. The method of claim 12, further comprising offering the contract to the investor.

40. The method of claim 25, wherein said received interval data is determined by one or more experts.

41. The method of claim 25, further comprising offering the contract to the investor.
